(19) United States
(12) Patent Application Publication
(10) Pub. No.: US 2018/0286259 A1
(43) Pub. Date: Oct. 4, 2018

(54) THREE DIMENSIONAL MULTIPLE OBJECT TRACKING SYSTEM WITH ENVIRONMENTAL CUES

(71) Applicant: WICHITA STATE UNIVERSITY, Wichita, KS (US)

(72) Inventor: Rui Ni, Andover, KS (US)

(21) Appl. No.: 15/935,414

(22) Filed: Mar. 26, 2018

Related U.S. Application Data
(60) Provisional application No. 62/601,681, filed on Mar. 28, 2017.

(51) Int. Cl. G09B 5/02; G06T 13/20; A63F 13/85; A63F 13/46

(52) U.S. Cl. CPC G09B 5/02; G06T 13/20; G06T 15/80; A63F 13/46; A63F 13/85

(57) ABSTRACT

A multiple object tracking system has a system controller with a placement block placing target objects and distractor objects within a 3D display space upon a representation of a solid ground, an assignment block assigning respective trajectories for movement of each of the objects, and an animation block defining an animated sequence of images showing the ground and the objects following the respective trajectories. A visual display presents images to a user including the animated sequence of images and a ground representation. A manual input device is adapted to respond to manual input from the user to select objects believed to be the target objects after presentation of the animated sequence. Preferably, the animation block incorporates a plurality of 3D cues applied to each of the objects, such as 3D perspective, parallax, 3D illumination, binocular disparity, and differing occlusion.

### CROSS REFERENCE TO RELATED APPLICATIONS

This application claims the benefit of U.S. Provisional Application Ser. No. 62/601,681, filed Mar. 28, 2017, which is incorporated herein by reference.

### STATEMENT REGARDING FEDERALLY SPONSORED RESEARCH

Not Applicable.

### BACKGROUND OF THE INVENTION

The present invention relates in general to training systems using multiple object tracking, and, more specifically, to presenting objects in a three-dimensional representation including environmental cues such as gravity and solid ground upon which objects move, resulting in improved efficacy of training.

In many important everyday activities, individuals need to monitor the movements of multiple objects (e.g., keeping track of multiple cars while driving, or monitoring running teammates and opponents while playing team sports like soccer or football). Previous research on multiple object tracking (MOT) as training tools have primarily employed a two-dimensional (2D) environment, which does not well represent many real word situations. Some training has been done using three-dimensional (3D) objects generated using stereoscopic techniques to create the appearance of three dimensions. However, the objects have still been generated in randomized locations with random trajectories in the entire 3D space, giving an appearance equivalent to objects floating in the air. Floating objects represent very rare situations in everyday activities.

Since humans and objects are normally restricted by gravity to the ground surface, the vast majority of tasks will not take place in a zero-gravity environment. In a task such as driving, cars never leave the roadway causing movement in the vertical direction to be restricted to a small range unless the car is driving on a steep slope.

Conventional multiple object tracking systems using a 3D display have relied on stereoscopic depth information as the only cue for representing distance to an object. However, in real world conditions, there are a variety of sources of depth information that observers use to sense the 3D environment. Thus, it would be desirable to incorporate rich depth information into the display and present much more ecologically valid scenarios that represent real world situations.

### SUMMARY OF THE INVENTION

It has been discovered that an individual's tracking capacity is diminished in 3D simulated environments for objects moving on a ground surface, as opposed to simulations relying only on stereoscopic depth information. Thus, the present invention develops an ecologically valid way to measure visual attention in space when attending and tracking multiple moving objects in a way that generalizes more effectively to real word activities.

The invention uses a more ecologically valid MOT task in a 3D environment where the targets and distractors are restricted to moving along a ground surface in a manner that simulates gravity. Additional 3D cues may preferably be included in the presentation of objects, including perspective, motion parallax, occlusion, relative size, and binocular disparity.

In one primary aspect of the invention, a multiple object tracking system comprises a system controller having a placement block placing target objects and distractor objects within a 3D display space upon a representation of a solid ground within the display space. The system controller further includes an assignment block assigning respective trajectories for movement of each of the objects along the ground. The system controller further includes an animation block defining an animated sequence of images showing the ground and the objects following the respective trajectories. A visual display presents images from the system controller to a user, wherein the presented images include the animated sequence of images. A manual input device is coupled to the system controller adapted to respond to manual input from the user to select objects believed to be the target objects after presentation of the animated sequence. Preferably, the animation block incorporates a plurality of 3D cues applied to each of the objects. The 3D cues are comprised of at least one of 3D perspective, parallax, 3D illumination, binocular disparity, and differing occlusion.

### BRIEF DESCRIPTION OF THE DRAWINGS

FIG. 1 is a display screen according to a prior art MOT training system during an initial indication of randomized target objects among distractor objects.

FIG. 2 is the display screen of FIG. 1 showing randomized trajectories given to the objects during a test.

FIG. 3 is a display screen according to one embodiment of the invention wherein a 3D environment includes a solid ground and 3D visual cues.

FIG. 4 is a diagram showing one preferred embodiment of the invention using a head-mounted VR display, smartphone, and handheld controller.

FIG. 5 is a flowchart showing one preferred embodiment for a series of tracking test trials.

FIG. 6 is a block diagram showing one preferred system architecture of the invention.

FIG. 7 is a display screen according to another preferred embodiment of the invention wherein a 3D environment includes a solid ground and 3D visual cues.

FIG. 8 is a block diagram showing object generation in greater detail.

FIG. 9 is a flowchart showing a high level diagram of software flow for one preferred implementation of the invention.

FIG. 10 is a flowchart showing a method for an individual pre-test or post-test.

### DETAILED DESCRIPTION OF PREFERRED EMBODIMENTS

The present invention is a system and method for training and evaluating a user (i.e., person) on cognitive capacity of multiple object tracking (MOT) in 3D space, which presents a series of tests to the subject in a three dimensional environment with reference to a ground surface. In each test, a sequence of animated images are presented to the subject on a 3D display, which can be either a computer-based 3D screen or a head-mounted display (HMD) of a type used in virtual reality (VR) applications wherein separate images are presented to the user's left and right eyes. In the animated image sequence, a series of objects are presented on the ground surface, wherein a number of targets are indicated as a subset of the objects during a first time period (the remaining objects being distractors). Thereafter, the indications are removed so that the targets mix with distractors. All objects, including targets and distractors, start to move during a second time period. At the end of the second time period, subjects are instructed to identify the targets. A subject's response is evaluated in such a way that the next test adjusts the difficulty accordingly. At the end of the series of tests, the subject's attentional capacity may be calculated. Repeated performance of the tests can be carried out over several days to improve the subjects' cognitive function and attentional capacity.

The invention presents the subject with a much richer depth information from different resources, such as ground surface, perspective, motion parallax, occlusion, relative size, and binocular disparity. The invention takes the real world 3D conditions into consideration when measuring and training visual attention and cognition in a more realistic 3D space. The method and apparatus will have much greater ecological validity and can better represent everyday 3D environments. The inventor has found that training with 3D MOT not only improves the subject's performance on trained MOT tasks but also generalizes to untrained visual attention in space. The application has broader implications where performance on many everyday activities can benefit from having used the invention. The invention can be used by, for example, insurance companies, senior service facilities, driving rehabilitation service providers, team sports coaches/managers (e.g., football or basketball coaches) at different levels (grade school, or college).

In each test of the assessment or training sessions, the target and distractor locations and initial motion vectors are pseudo-randomly generated. A predetermined number among the total number of objects (e.g., 10 spheres) are indicated as targets at the beginning of each test. Then all objects travel in predetermined trajectories (e.g., linear or curved) until making contact with a wall or other object, at which point they are deflected. Thus, the objects may appear to bounce off each other.

Once the object motion phase ends, users will be instructed to indicate which items they believe to be targets by using a mouse/keyboard (when using a PC) or using a custom controller (when using smartphone-based or gaming console-based VR). The number of correctly selected targets will count towards a positive number of earned credits. At the end of an assessment/training session, an overall score will be assigned to the user, with his/her own top five historical performance displayed as a reference.

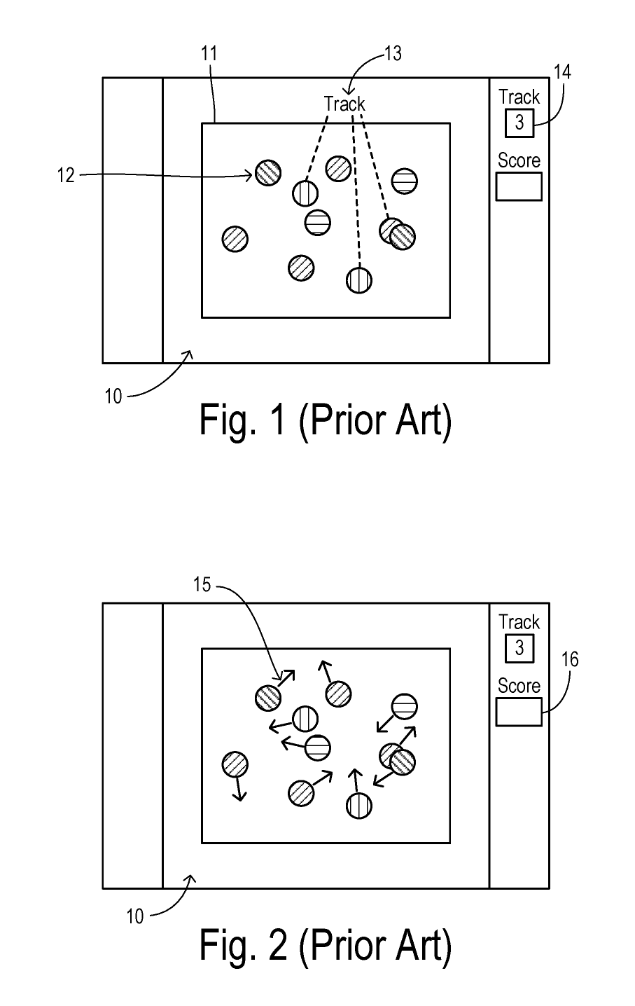

FIGS. 1 and 2 show a display screen 10 for a conventional MOT system based on identical objects given randomized positions and trajectories in an arbitrary space viewed within a window 11. A plurality of objects 12 are pseudo-randomly placed within window 11. Objects 12 are typically generated as identical circles (e.g., all the same size and color, at least during the mixing and selection phases). At a first time in FIG. 1, an indicator 13 is shown which informs the testing/training subject which objects are the targets to be tracked. Besides text labeling, other indicators that can be used include blinking the target objects or temporarily displaying them with a contrasting color. A box 14 is also presented on screen 10 as a reminder to the subject of how many objects are to be tracked. A scoring box 16 as well as other testing/training prompts or counters can also be presented on screen 10.

The random placement of objects 12 in the prior art has included use of a simulated three-dimensional space in which one object can pass behind another. The placed objects 12 are assigned respective random trajectories 15 to follow during the mixing phase as shown in FIG. 2. Trajectories 15 can be straight or curved, and can include reflections against the sides of window 11 or against other objects. In a 3D space, trajectories 15 can include a depth component (i.e., along the z-axis). In the prior art, the chosen trajectories in the 3D space are arbitrary in the sense that objects 12 move in a weightless environment.

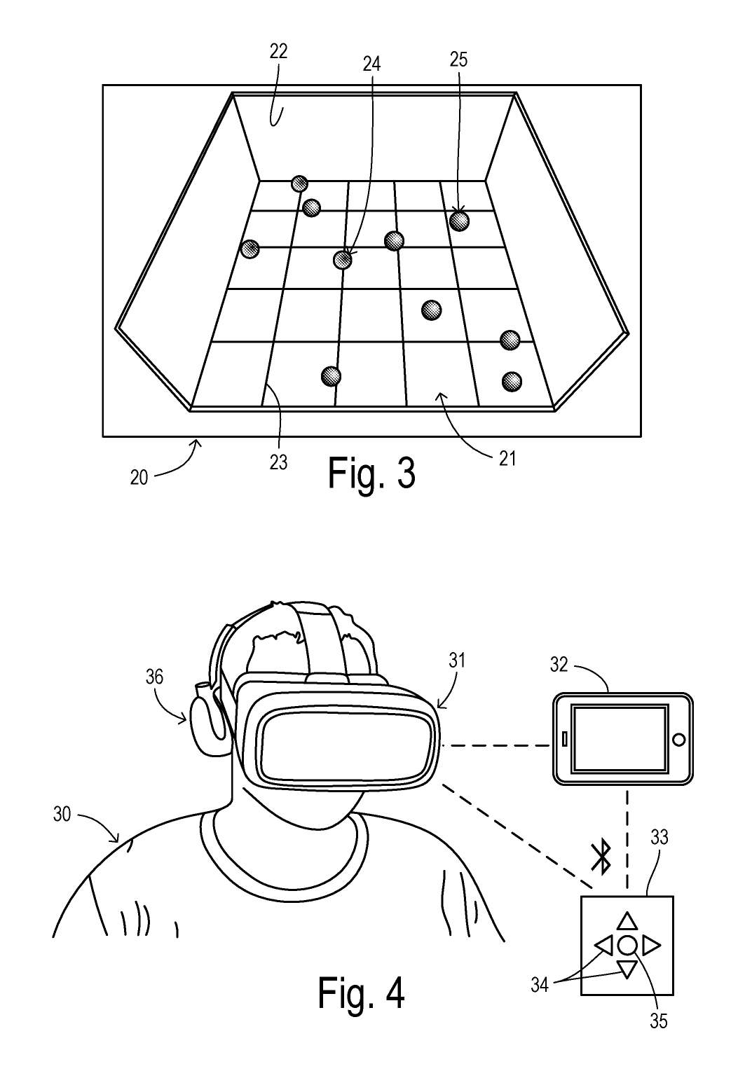

FIG. 3 shows a display screen 20 of a first embodiment of the invention wherein a 3D ground surface 21 and side walls 22 provide a realistic environment for movement of 3D object including tracked objects 24 (shown with light shading in an identification phase) and distractor objects 25 (shown with darker shading). Ground surface 21 may include a distinct shading or color along with a plurality of 3D grid lines 23. The embodiment of FIG. 3 can be implemented using a general purpose computer with a 3D display (e.g., monitors and graphic cards compatible with NVidia 3D vision). A keyboard or a mouse can be used for obtaining input from the user.

In placing and assigning trajectories to objects 24 and 25, a downward force of gravity is simulated by controlling the appearance and movement of objects 24 and 25 to be upon and along ground surface 21. Various techniques for defining ground surface 21 and objects 24 and 25 are well known in the field of computer graphics (e.g., as used in gaming applications). Additional 3D cues may preferably be included in the presentation of 3D objects on a monitor (i.e., a display screen simultaneously viewed by both eyes), such as adding perspective (e.g., depth convergence) to the environment and objects, simulating motion parallax, occlusion of objects moving behind another, scaling the relative sizes of objects based on depth, 3D illumination (e.g., shading and shadows), and adding 3D surface textures.

Other embodiments of the invention may present different left and right images to the left and right eyes for enhanced 3D effects using virtual reality (VR) headsets. The VR headset can be a standalone display (i.e., containing separate left and right display screens), such as the Oculus Rift headset available from Oculus VR, LLC, or the Vive™ headset available from HTC Corporation. The VR headset can alternatively be comprised of a smartphone-based (e.g., Android phone or iPhone) VR headset having left and right lenses/eyepieces adjacent a slot for receiving a phone. Commercially available examples include the Daydream View headset from Google, LLC, and the Gear VR headset from Samsung Electronics Company, Ltd. Images from the display screen of the phone are presented to the eyes separately by the lenses. A typical VR headset is supplied with a wireless controller that communicates with the smartphone or standalone headset via Bluetooth.

A VR-headset-based embodiment is shown in FIG. 4. A user 30 is wearing a VR headset 31. In a standalone system, headset 31 may incorporate dual displays and a processor containing appropriate hardware and software for executing a training/testing system as described herein. In a smartphone system, headset 31 accepts a smartphone 32 for providing the necessary display and computing resources. In any case, a handheld, wireless controller 33 provides manual inputs including direction buttons 34 and a select or enter button 35. Direction buttons 34 (e.g., Left, Right, Up, and Down) can be used to selectably highlight different objects or menu items, while select button 35 is used to confirm a selection. A double click of select button 35 can be used to move the test to the next trial or scenario. Smartphone 32 or a standalone VR headset 31 can be wirelessly coupled to a network server (not shown) which collects user performance data from the computing device and can provide commands to the processor for adjusting the test or training parameters for a particular user. A Bluetooth connection may also be used with headphones 36 which can be used to provide auditory feedback or prompts to user 30.

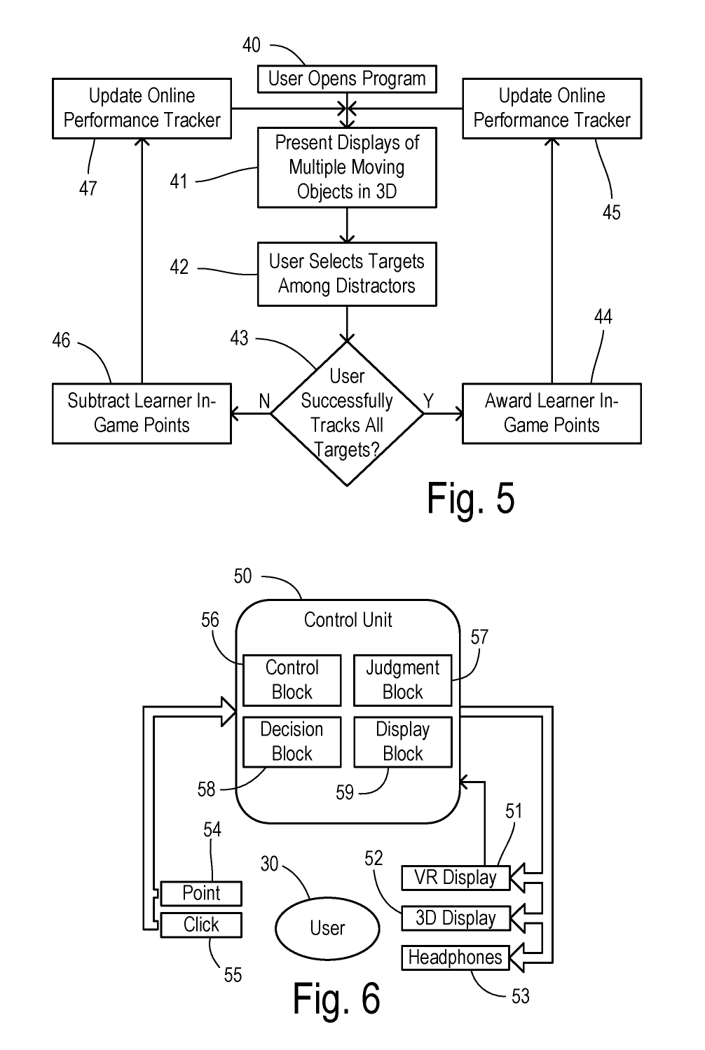

FIG. 5 shows a preferred method for an individual test trial or training session within which target object and distractor object locations and initial motion vectors are pseudo-randomly generated. After a user opens the corresponding application program in step 40, a predetermined number of objects (such as three spheres out of a total of 10 spheres) are indicated as target objects at the beginning of each trial. In step 41, the invention displays multiple moving objects in 3D according to an animated sequence of images. The animated sequence is generated such that all objects travel along respective trajectories until making contact with a wall or other object, at which point they are deflected. Once the object motion period ends, the user selects targets from among the distractors in step 42. Selection is performed among the objects using a mouse or keyboard (when the invention is implemented on a PC) or using a remote hand-held controller (when implemented on a VR headset system). A determination is made in step 43 whether the user successfully tracked all the target objects. If so, then Learner In-Game points are awarded to the user in step 44. The user's performance profile or tracker may be updated in step 45 (e.g., as stored on a network server). If not all target objects were successfully tracked then the user may lose Learner In-Game points in step 46 and the online performance profile is updated accordingly in step 47. After updating an online performance profile, the method returns to step 41 for conducting additional tests or training sessions.

A functional block diagram of the invention is shown in FIG. 6. Whether implemented using a PC or a smartphone, a control unit 50 in the corresponding system is configured to drive a VR display 51 in a VR headset and/or a 3D display 52 for a PC-based system. Control unit 50 is preferably coupled with headphones 53 for providing instructions and other information to a user. A user input device includes a pointer 54 and clicker 55 which supply the user's manual input to control unit 50. Control unit 50 preferably is comprised of a control block 56, a judgment block 57, a decision block 58, and a display block 59. Control block 56 controls the overall organization and operation of the application trials and the scoring functions, for example. Judgment block 57 evaluates user input to determine whether correct selection of targets has been made or not. Judgment block 57 may generate auditory feedback to be presented to the user via headphones 53 in order to prompt the collection of user input or to inform the user of the occurrence of errors. For example, if there are four targets to be tracked and selected but the user attempts to continue after only selecting three objects, there may be a buzzing sound to indicate that not enough targets have been selected. Similarly, if a user attempts to select more targets than necessary, then auditory feedback may prompt them to deselect one of the selected objects before proceeding to the next test trial.

In decision block 58, performance of users can be evaluated in an adaptive way in order to progress successive trials to more difficult or challenging test conditions when user exhibits successful performance or to progress to easier conditions otherwise. An adaptive process helps ensure that the user continues to be challenged while avoiding frustration from having extremely difficult test conditions.

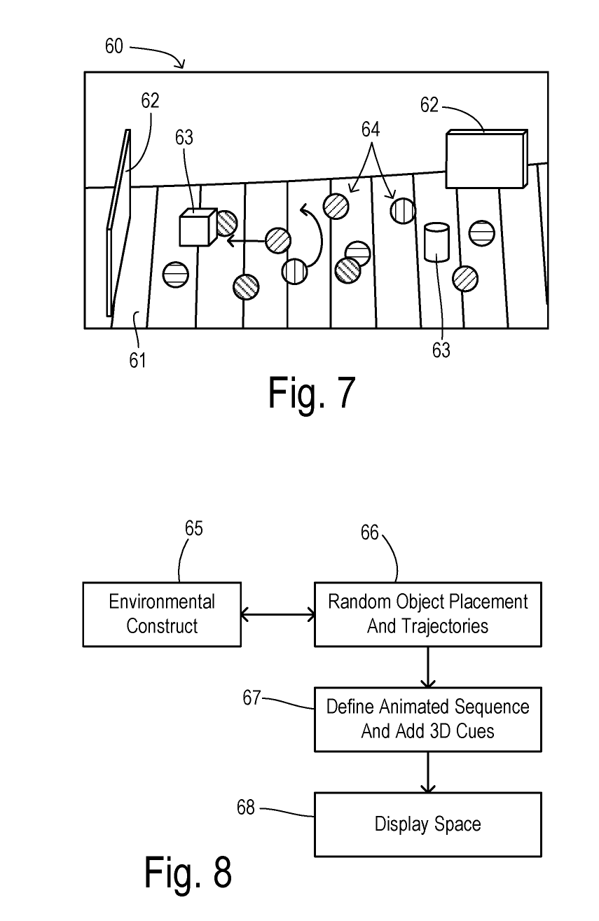

Display block 59 handles the creation and animation of the 3D objects and environment. A three-dimensional scene may be created corresponding to the example initial conditions shown in FIG. 7. A visual display 60 includes a representation of solid ground 61 upon which all other visual elements rest or move upon. Stationary objects may include sidewalls 62 or intermediate barriers 63. Barriers 63 may have flat or round sides, and they may at times hide a portion of a moving object or receive a collision from a moving object. Objects 64 are movable according to their assigned trajectories. The respective trajectories typically include at least one curved path and one straight path along the ground. The respective trajectories preferably also include at least one path having a collision followed by a rebound segment along the ground.

Each object 64 is preferably comprised of a substantially identical sphere. Although spheres are shown, other shapes can also be used. Although objects 64 may preferably all have the same color, texture, or other salient characteristics (at least prior to adding 3D cues as discussed below), they can alternatively exhibit differences in appearance such as color or texture as long as they do not reveal the identities of tracked objects. Uniform spheres are generally the most preferred objects because they are the most featureless 3D objects. Thus, any training benefits will not be restricted to the trained type of object and will better generalize to the numerous object shapes and types in the real world. Nevertheless, it is possible to modify the display to meet a special need in a certain context (e.g., have soldiers to keep track of a number of military vehicles, such as tanks).

Display block 59 may be organized according to the block diagram of FIG. 8. An block 65 stores an environmental construct, preferably including a plurality of environment definitions such as 1) a spatial topology including a solid ground, 2) rules for gravity, 3) locations and properties of stationary objects, and 4) collision dynamics (e.g., parameters for modeling inelastic collisions). A block 66 performs random object placement and trajectory assignments by interacting with environmental construct 65 in a manner that is adapted to achieve desired characteristics for the multiple object tracking task (e.g., adapting the environment for particular types of training such as driver awareness or sports performance). A graphical processing or animation block 67 receives the random object placement, trajectory assignments, and overall environmental parameters to define an animated sequence of images according to a mixing phase of each test trial. Block 67 further adds additional 3D graphical cues to assist the human visual system to perceive and judge depth/distance of objects within the 3D environment. The objects and the animated sequence for the mixing phase are input into a display space 68 for presentation to the user.

There is a variety of 3D information that the human visual system uses to perceive and judge depth/distance of objects in 3D environments. The 3D cues include binocular information (which requires different images being sent to each eye, such as with a stereoscopic display) and monocular information (which uses a single image display). Binocular disparity is one source of binocular information, which represents the angular difference between the two monocular retina images (that any scene projects to the back of our eyes). Another binocular 3D cues is differing occlusion, wherein different portions of an object are obscured by an intervening object for each eye.

Monocular 3D cues do not rely on binocular processing (i.e., you can close one eye and will still experience a 3D view). Monocular cues include texture gradient, light illumination (i.e., shading and shadowing), motion parallax, perspective, and occlusion. Texture gradients indicate that the farther the distance, the smaller the projected retina image is for the texture (e.g., tiles, grass, or surface features). Motion parallax is a dynamic depth cue referring to the fact that when we are in motion, near objects appear to move rapidly in the opposite direction. Objects beyond fixation, however, will appear to move much more slowly, often in the same direction we are moving.

3D cues can be added by animation block 67 using known tools and methods. For example, computer graphics software such as OpenGL library and Unreal Engine 4 have been successfully used in an application in the C++ programming languages to create animated sequences.

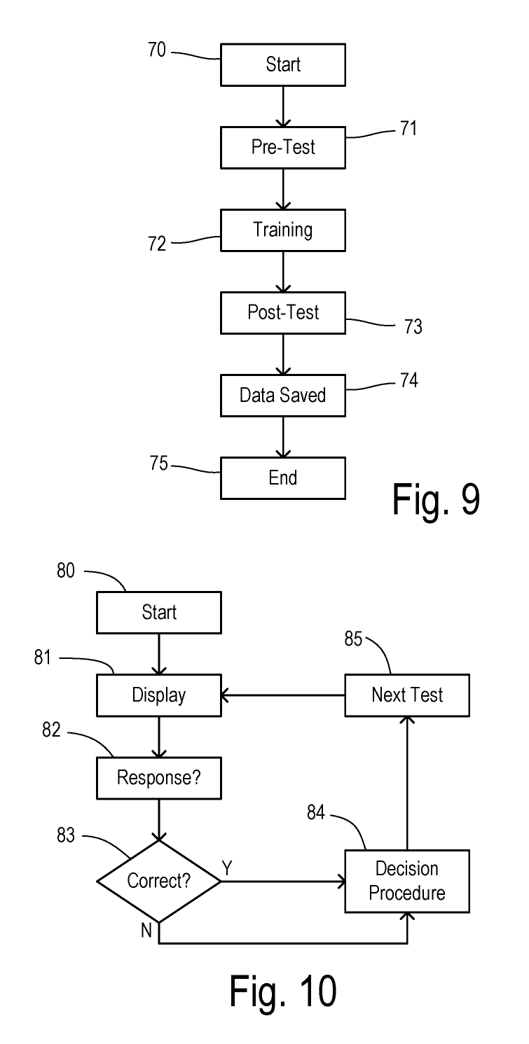

The invention is adapted to operate well in a system for testing and improving cognitive capacity of visual attention. FIG. 9 shows a preferred method for an overall software flow of the invention. Upon launching of a software application by a user in step 70, a multiple object tracking trial is conducted as a pre-test in step 71. The pre-test establishes a user's baseline performance. Next, training trials or sessions are conducted at step 72. After a desired training interval, a post-test is conducted at step 73 to evaluate the impact of training. In step 74, the user's data is saved in a tracking profile and the application ends at step 75.

FIG. 10 shows an overall method for conducting during an individual pre-test or post-test. A test trial starts in step 80 which defines various parameters for a test and an animated image sequence for the trial. A 3D multiple object tracking display is shown to the user in step 81. After completing a corresponding presentation of an animated sequence of images for tracking multiple target objects, the method obtains a user response in step 82 for collecting the user's best guess at which objects correspond to the tracked objects. In step 83, the user response is evaluated to determine whether it is correct. A positive or negative result is utilized in step 84 for performing a decision procedure to determine whether the tracking difficulty of a next test trial should be increased or decreased. Based on the decision, a next test begins at step 85 which sets up an image sequence for the next test which is then displayed at step 81. Thus, each trial includes an indication phase identifying the target objects, a mixing phase advancing through the animated sequence of images with the objects following the respective trajectories, and a selection phase responsive to the manual input.

What is claimed is:

1. A multiple object tracking system, comprising:
a system controller having a placement block placing target objects and distractor objects within a 3D display space upon a representation of a solid ground within the display space, an assignment block assigning respective trajectories for movement of each of the objects along the ground, and an animation block defining an animated sequence of images showing the ground and the objects following the respective trajectories;
a visual display presenting images from the system controller to a user, wherein the presented images include the animated sequence of images; and
a manual input device coupled to the system controller adapted to respond to manual input from the user to select objects believed to be the target objects after presentation of the animated sequence.

2. The system of claim 1 wherein the animation block incorporates a plurality of 3D cues applied to each of the objects, and wherein the 3D cues are comprised of at least one of 3D perspective, parallax, and 3D illumination.

3. The system of claim 2 wherein perspective is comprised of distance scaling and convergence.

4. The system of claim 2 wherein 3D illumination is comprised of shading and shadowing.

5. The system of claim 2 wherein the visual display presents stereoscopic views to a left eye and a right eye of the user, and wherein the 3D cues are comprised of at least one of binocular disparity and differing occlusion.

6. The system of claim 1 wherein the respective trajectories includes at least one curved path.

7. The system of claim 1 wherein the respective trajectories includes at least one path having a collision followed by a rebound segment along the ground.

8. The system of claim 1 wherein the presentation of images by the visual display includes an indication phase identifying the target objects, a mixing phase advancing through the animated sequence of images with the objects following the respective trajectories, and a selection phase responsive to the manual input.

9. A method for multiple object tracking comprising the steps of:
placing target objects and distractor objects within a 3D display space upon a representation of a solid ground within a display space;
assigning respective trajectories for movement of each of the objects along the ground;
defining an animated sequence of images showing the ground and the objects following the respective trajectories;
presenting the animated sequence of images to a user;
receiving manual input from a user selecting objects believed by the user to be the target objects after presentation of the animated sequence; and
updating a user score in response to comparing identities of the target objects to select objects.

10. The method of claim 9 further comprising the step of incorporating a plurality of 3D cues applied to each of the objects, wherein the 3D cues are comprised of at least one of 3D perspective, parallax, and 3D illumination.

11. The method of claim 10 wherein perspective is comprised of distance scaling and convergence.

12. The method of claim 10 wherein 3D illumination is comprised of shading and shadowing.

13. The method of claim 10 wherein the step of presenting the animated sequence of images include respective stereoscopic views presented to a left eye and a right eye of the user, and wherein the 3D cues are comprised of at least one of binocular disparity and differing occlusion.

14. The method of claim 9 wherein the respective trajectories includes at least one curved path.

15. The method of claim 9 wherein the respective trajectories includes at least one path having a collision followed by a rebound segment along the ground.

16. The method of claim 9 comprising an indication phase identifying the target objects, a mixing phase advancing through the animated sequence of images with the objects following the respective trajectories, and a selection phase responsive to the manual input.
